(19) United States
(12) Patent Application Publication
(10) Pub. No.: US 2021/0341588 A1
(43) Pub. Date: Nov. 4, 2021

(54) RANGING DEVICE AND MOBILE PLATFORM

(71) Applicant: SZ DJI TECHNOLOGY CO., LTD., Shenzhen (CN)

(72) Inventors: Shuai DONG, Shenzhen (CN); Xiaoping Hong, Shenzhen (CN)

(21) Appl. No.: 17/369,475

(22) Filed: Jul. 7, 2021

Related U.S. Application Data
(63) Continuation of application No. PCT/CN2019/070694, filed on Jan. 7, 2019.

(51) Int. Cl. G01S 7/481; G02B 27/30; G01S 17/10; G02B 27/09; G02B 3/04; G02B 26/10

(52) U.S. Cl. CPC G01S 7/4817; G02B 27/30; G02B 26/108; G02B 27/0955; G02B 3/04; G01S 17/10

(57) ABSTRACT

A ranging device includes a transmitter, a collimation element, a converging element, a detector, and at least one of a first pre-shaping element or a second pre-shaping element. The transmitter is configured to emit a light pulse sequence. The collimation element is configured to collimate the light pulse sequence. The converging element is configured to converge at least part of reflected light reflected by an object. The detector is configured to receive and convert the at least part of the reflected light to an electrical signal, and determine at least one of a distance or an orientation of the object with respect to the ranging device according to the electrical signal. An effective aperture of the collimation element is greater than an effective aperture of the first pre-shaping element, and an effective aperture of the converging element is greater than an effective aperture of the second pre-shaping element.

### CROSS-REFERENCE TO RELATED APPLICATION

This application is a continuation of International Application No. PCT/CN2019/070694, filed Jan. 7, 2019, the entire content of which is incorporated herein by reference.

### TECHNICAL FIELD

The present disclosure relates to the technical field of ranging and, more particularly, to a ranging device and a mobile platform.

### BACKGROUND

Ranging devices play a significant role in many fields, such as for a mobile carrier or a non-mobile carrier, for remote sensing, obstacle avoidance, surveying and mapping, modeling, environmental perception, etc. In particular, the mobile carrier, such as a robot, a manually controlled aircraft, an unmanned aerial vehicle, a vehicle, or a ship, can navigate in a complex environment by the ranging device to achieve path planning, obstacle detection, obstacle avoidance, etc.

The ranging device usually uses a semiconductor laser as a light source. However, because of a large divergence angle and a large difference in fist and slow axis BPP (a product of beam parameters in slow axis and fast axis direction) of the semiconductor laser, beam collimation or compression is required in many applications. Traditional narrow beam collimation is mostly realized by using a cylindrical Los or a cylindrical lens array near a light-emission surface, and wide beam collimation is usually realized by using a single aspheric lens or a cemented spherical lens group. However, for some cases where wide beams and large apertures (>30 mm) are required, because light spot size is too large, required lens aperture will increase accordingly, which is a challenge tor high-index lens processing. In many cases, corresponding lens parameters can be designed, but it cannot be processed or processing cost is relatively high, which affects a mass production of products. In addition, large-aperture optical systems using large-aperture lenses also have the following detects: 1) Single large-aperture lens has poor optical performance and poor system performance; 2) If multiple large-aperture lenses are used, the optical system is bulky and costly; 3) If a large-aperture aspheric lens is used, processing is difficult and cost is high.

Therefore, it is needed to improve the ranging device to solve the above technical problems.

### SUMMARY

In accordance with the disclosure, there is provided a ranging device including a transmitter, a collimation element, a converging element, a detector, and at least one of a first pre-shaping element or a second pre-shaping element. The transmitter is configured to emit a light pulse sequence. The collimation element is configured to collimate the light pulse sequence. The converging element is configured to converge at least part of reflected light reflected by an object. The detector is configured to receive and convert the at least part of the reflected light to an electrical signal, and determine at least one of a distance or an orientation of the object with respect to the ranging device according to the electrical signal. An effective aperture of the collimation element is greater than an effective aperture of the first pre-shaping element, and an effective aperture of the converging element is greater than an effective aperture of the second pre-shaping element.

Also in accordance with the disclosure, there is provided a mobile platform including a platform body and a ranging device mounted at the platform body. The ranging device includes a transmitter, a collimation element, a converging element, a detector, and at least one of a first pre-shaping element or a second pre shaping element. The transmitter is configured to emit a light pulse sequence. The collimation element is configured to collimate the light pulse sequence. The converging element is configured to converge at least part of reflected light reflected by an object. The detector is configured to receive and convert the at least part of the reflected light to an electrical signal, and determine at least one of a distance or an orientation of the object with respect to the ranging device according to the electrical signal. An effective aperture of the collimation element is greater than an effective aperture of the first pre-shaping element, and an effective aperture of the converging element is greater than an effective aperture of the second pre-shaping element.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 shows a schematic block diagram of a ranging device according to an embodiment of the present disclosure.

FIG. 2 shows a schematic diagram of a ranging device according to another embodiment of the present disclosure.

FIG. 3 shows a schematic diagram of a ranging module included in a ranging device according to an embodiment of the present disclosure.

FIG. 4 is a schematic diagram showing positional relationship of primary elements on transmission light path of the ranging module of FIG. 3.

FIG. 5 shows a schematic diagram of a ranging module included in a ranging device according to another embodiment of the present disclosure.

FIG. 6 shows a schematic diagram of a ranging module included in a ranging device according to another embodiment of the present disclosure.

FIG. 7 shows a schematic diagram of a ranging module included in a ranging device according to another embodiment of the present disclosure.

### DETAILED DESCRIPTION OF THE EMBODIMENTS

In order to make the objectives, technical solutions, and advantages of the present disclosure more obvious, exemplary embodiments according to the present disclosure will be described in detail below with reference to the accompanying drawings. Obviously, the described embodiments are sonic of rather than all the embodiments of the present disclosure. It should be noted that the present disclosure is not limited by the exemplary embodiments described herein. Based on the embodiments of the present disclosure described in the present disclosure, all other embodiments obtained by those of ordinary skill in the art without inventive effort shall fall within the scope of the present disclosure.

In the following description, a lot of specific details are given in order to provide a more thorough understanding of the present disclosure. However, it is obvious to those skilled in the art that the present disclosure can be implemented without one or more of these details. In some other examples, some technical features known in the art are not described in order to avoid confusion with the present disclosure.

It should be noted that the present disclosure can be implemented in different forms and should not be construed as being limited to the embodiments described here. Rather, these embodiments are provided so that the disclosure will be thorough and complete, and the scope of the present disclosure will be fully conveyed to those skilled in the art.

The terms used herein is for the purpose of describing specific embodiments only and is not as a limitation of the present disclosure. As used herein, the singular forms of “a,” “an,” and “the” are intended to include plural forms as well, unless the context clearly indicates otherwise. It should also be understood that the terms “comprising,” and/or “including”, when used in this specification, determine the existence of the described features, integers, steps, operations, elements and/or components, but do not exclude the existence or addition of one or more other features, integers, steps, operations, elements, components, and/or groups. As used herein, the term “and/or” includes any and all combinations of related listed items.

In order to provide a thorough understanding of the present disclosure, detailed steps and detailed structures will be presented in the following description to explain the technical solutions of the present disclosure. Some embodiments of the present disclosure are described in detail as follows. However, in addition to these detailed descriptions, the present disclosure may also have other embodiments.

In order to solve the above problems, the present disclosure provides a ranging device, which includes a transmitter, a collimation element, a converging element, a first pre-shaping element and/or a second pre-shaping element. The transmitter is configured to emit a light pulse sequence. The collimation element is located on transmission light path of the transmitter, and is configured to collimate the light pulse sequence emitted by the transmitter and emit the collimated light pulse sequence out of the ranging device. The converging element is configured to converge at least part of reflected light reflected by an object to a detector. The detector is configured to receive at least part of the reflected light and convert to an electrical signal, and determine distance and/or orientation of the object from the ranging device according to the electrical signal. The first pre-shaping element is arranged on the transmission light path and between the collimation element and a light-emission surface of the transmitter, and the second pre-shaping element is arranged on reception light path of the reflected light and between the converging element and photosensitive surface of the detector. Effective aperture of the collimation element is greater than effective aperture of the first pre-shaping element, and effective aperture of the converging element is greater than effective aperture of the second pre-shaping element.

It should be noted that the effective aperture of each element (e.g., collimation element, pre-shaping element, etc.) herein refers to aperture of each element that actually receives a light beam.

The ranging device in the embodiments of the present disclosure combines small aperture pre-shaping element and collimation element and/or a converging element as an optical system for light beam collimation, which can achieve excellent optical performance with a large-aperture lens at a lower cost, and reduce aberration of the optical system, etc., thereby improving performance of the ranging device.

Hereinafter, a ranging device and a mobile platform in the present disclosure will be described in detail with reference to the accompanying drawings. In the case of no conflict, the embodiments and features in the embodiments can be combined with each other.

The ranging device in the embodiments of the present disclosure may be an electronic equipment such as a laser radar or a laser ranging equipment. In some embodiments, the ranging device is configured to sense external environment information, and data recorded in form of points by scanning external environment can be referred to as point cloud data. Each point in the point cloud data includes coordinates of a three-dimensional point and characteristic information of the corresponding three-dimensional point, such as distance information, orientation information, reflection intensity information, speed information, etc. of an environmental target. In one implementation manner, the ranging device can detect distance of a detected object to the ranging device by measuring time of light propagation, that is, time-of-flight (TOF), between the ranging device and the detected object. The ranging device can also detect the distance from the detected object to the ranging device by other techniques, such as a ranging method based on phase shift measurement or a ranging method based on frequency shift measurement, which is not limited herein.

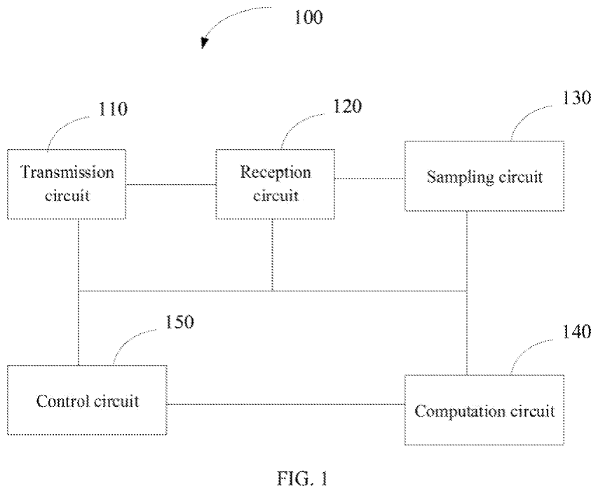

For better understanding, a ranging workflow will be described with examples in conjunction with a ranging device 100 shown in FIG. 1.

As shown in FIG. 1, the ranging device 100 includes a transmission circuit 110, a reception circuit 120, a sampling circuit 130, and a computation circuit 140.

The transmission circuit 110 can emit a light pulse sequence (e.g., a laser pulse sequence). The reception circuit 120 can receive the light pulse sequence reflected by a detected object and perform photoelectric conversion on the light pulse sequence to obtain an electrical signal, and then the electrical signal is processed and output to the sampling circuit 130. The sampling circuit 130 can sample the electrical signal to obtain a sampling result. The computation circuit 140 can determine distance between the ranging device 100 and the detected object based on the sampling result of the sampling circuit 130.

For example, the ranging device 100 also includes a control circuit 150, which can control other circuits, for example, can control operation time of each circuit and/or set parameters for each circuit.

It should be noted that although the ranging device shown in FIG. 1 includes a transmission circuit, a reception circuit, a sampling circuit, and a computation circuit, and is configured to emit a light beam for detection, the embodiments of the present disclosure are not limited thereto. Number of any one of the transmission circuit, the reception circuit, the sampling circuit, and the computation circuit may also be at least two, which are configured to emit at least two light beams in same direction or in different directions. The at least two light beams may be emitted simultaneous or may be emitted at different times. In some embodiments, light emitting chips in the at least two transmission circuits are packaged in same module. For example, each transmission circuit includes a laser emitting chip, and dies of the laser emitting chips in the at least two transmission circuits are packaged together and housed in same package space.

In some implementations, in addition to the circuits shown in FIG. 1, the ranging device 100 may also include a scanner for changing propagation direction of at least one light pulse sequence emitted by the transmission circuit.

A module including the transmission circuit 110, the reception circuit 120, the sampling circuit 130, and the computation circuit 140, or a module including the transmission circuit 110, the reception circuit 120, the sampling circuit 130, the computation circuit 140, and the control circuit 150 may be referred to as a ranging module, which can be independent of other modules, such as the scanner.

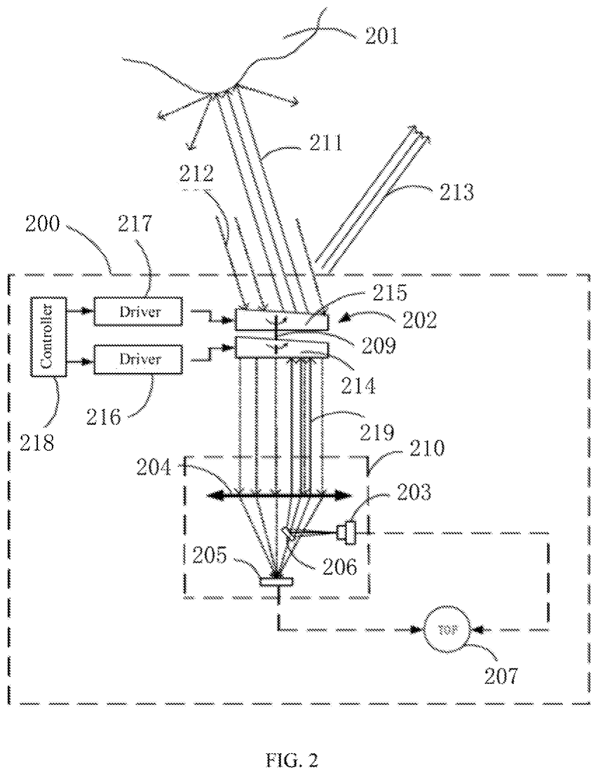

A coaxial light path can be used in the ranging device, that is, the light beam emitted by the ranging device and the reflected light beam share at least part of the light path within the ranging device. For example, after at least one laser pulse sequence emitted by the transmission circuit changes its propagation direction and emits through the scanner, the laser pulse sequence reflected by the detected object passes through the scanner and then enters the reception circuit. An off-axis light path can also be used in the ranging device, that is, the light beam emitted by the ranging device and the reflected light beam are respectively transmitted along different light paths within the ranging device. FIG. 2 shows a schematic diagram of a ranging device using a coaxial light path according to an embodiment of the present disclosure.

A ranging device 200 includes a ranging module 210, which includes a transmitter 203 (which may include the transmission circuit described above), a collimation element 204, a detector 205 (which may include the reception circuit, the sampling circuit, and the computation circuit described above), and a light path changing element 206. The ranging module 210 is configured to emit the light beam, receive the reflected light, and convert the reflected light into the electrical signal. The transmitter 203 can be configured to emit the light sequence. In some embodiments, the transmitter 203 may emit the laser pulse sequence. For example, a laser beam emitted by the transmitter 203 is a narrow-bandwidth beam with a wavelength outside visible light range.

The collimation element 204 is arranged on the transmission light path of the transmitter, and is configured to collimate the light beam emitted from the transmitter 203 and collimate the light beam emitted from the transmitter 203 into parallel light output to the scanner. In the coaxial light path, the collimation element is also configured to converge at least part of the reflected light reflected by the detected object. The collimation element 204 may be a collimating lens or another element capable of collimating the light beam.

In the embodiments shown in FIG. 2, the transmission light path and the reception light path within the ranging device are merged before the collimation element 204 by the light path changing element 206, so that the transmission light path and the reception light path can share the same collimation element, such as sharing a same transceiver lens, which makes the light path more compact. For example, the light path changing element is located within a back focal length of the collimation element 204, which is configured to change the transmission light path of the light pulse sequence emitted by the transmitter or the reception light path of the reflected light passing through the collimation element 204, so that the transmission light path and the reception light path are merged. For example, the light path changing element 206 includes a reflector and/or a prism. The reflector includes at least one of a flat reflector or a concave reflector.

In some other implementations, the transmitter 203 and the detector 205 may respectively use their own collimation elements. For example, the transmitter 203 uses the collimation element, while the detector uses the converging element with a converging effect, and the light path changing element 206 is arranged on the light path behind the collimation element.

In the embodiment shown in FIG. 2, since beam aperture of the light beam emitted by the transmitter 203 is small, and beam aperture of the reflected light received by the ranging device is large, the light path changing element can use a small-area reflector to merge the transmission light path and the reception light path. In some other implementations, the light path changing element may also use a reflector with a through hole, where the through hole is used to transmit emitted light of the transmitter 203 and the reflector is used to reflect the reflected light to the detector 205, which can reduce block of the reflected light from a support of a small reflector in case of using the small reflector.

In the embodiments shown in FIG. 2, the light path changing element is deviated from an optical axis of the collimation element 204, which is configured to project the light pulse sequence emitted by the transmitter to an edge field of view of the transceiver lens. In some other implementations, the light path changing element may also be located on the optical axis of the collimation element 204.

The ranging device 200 also includes a scanner 202 arranged on the transmission light path of the ranging module 210. The scanner 202 is configured to change transmission direction of a collimated light beam 219 emitted by the collimation element 204 and project it to external environment. The reflected light is projected to the collimation element 204, and is converged on the detector 205 through the collimation element 204.

In some embodiments, the scanner 202 may include at least an optical element for changing propagation path of the light beam, and the optical element may change the propagation path of the light beam by reflecting, refracting, diffracting, etc. For example, the scanner 202 includes a lens, a reflector, a prism, a galvanometer, a grating, a liquid crystal, an optical phased array, or any combination of the above. In some embodiments, at least some of the optical elements are movable, for example, the at least some of the optical elements are driven to move by a drive module, and the movable optical element can reflect, refract or diffract the light beam to different directions at different times. In some embodiments, the multiple optical elements of the scanner 202 can rotate or vibrate around a common rotation axis 209, and each rotating or vibrating optical element is configured to continuously change the propagation direction of an incident light beam. In some embodiments, the multiple optical elements of the scanner 202 may rotate at different rotation speeds or vibrate at different speeds. In some other embodiments, the at least some of the optical elements of the scanner 202 may rotate at substantially the same rotation speed. In some embodiments, the multiple optical elements of the scanner may also rotate around different axes. In some embodiments, the multiple optical elements of the scanner may also rotate in the same direction or in different directions; or vibrate in the same direction or in different directions, which is not limited herein.

In some embodiments, the scanner 202 includes a first optical element 214 and a driver 216 connected to the first optical element 214. The driver 216 is configured to drive the first optical element 214 to rotate around the rotation axis 209, such that the first optical element 214 changes the direction of the collimated light beam 219, and the first optical element 214 projects the collimated light beam 219 to different directions. In some embodiments, angle between the direction of the collimated light beam 219 changed by the first optical element and the rotation axis 209 varies with the rotation of the first optical element 214. In some embodiments, the first optical element 214 includes a pair of opposing non-parallel surfaces through which the collimated light beam 219 passes. In some embodiments, the first optical element 214 includes a prism that varies in thickness along at least a radial direction. In some embodiments, the first optical element 214 includes a wedge angle prism that refracts the collimated light beam 219.

In some embodiments, the scanner 202 also includes a second optical element 215 that rotates around the rotation axis 209, and the rotation speed of the second optical element 215 is different from the rotation speed of the first optical element 214. The second optical element 215 is configured to change the direction of the light beam projected by the first optical element 214. In some embodiments, the second optical element 215 is connected to another driver 217 that drives the second optical element 215 to rotate. The first optical element 214 and the second optical element 215 can be driven by the same or different drivers, so that the rotation speed and/or rotation direction of the first optical element 214 and the second optical element 215 are different, thereby projecting the collimated light beam 219 to different directions in outside space, and a larger space can be scanned. In some embodiments, a controller 218 controls the drivers 216 and 217 to drive the first optical element 214 and the second optical element 215, respectively. The rotation speeds of the first optical element 214 and the second optical element 215 may be determined according to area and pattern expected to be scanned in actual applications. The drivers 216 and 217 may include motors or other drivers.

In some embodiments, the second optical element 215 includes a pair of opposing non-parallel surfaces through which the light beam passes. In some embodiments, the second optical element 215 includes a prism that varies in thickness along at least a radial direction. In some embodiments, the second optical element 215 includes a wedge angle prism.

In some embodiments, the scanner 202 also includes a third optical element (not shown) and a driver for driving the third optical element to move. For example, the third optical element includes a pair of opposing non-parallel surfaces through which the light beam passes. In some embodiments, the third optical element includes a prism that varies in thickness along at least a radial direction. In some embodiments, the third optical element includes a wedge angle prism. At least two of the first, second, and third optical elements rotate at different rotation speeds and/or rotation directions.

Each optical element in the scanner 202 can rotate to project light to different directions, such as directions of projected light 211 and projected light 213, so that a space around the ranging device 200 is scanned. When the projected light 211 projected by the scanner 202 hits a detected object 201, part of the light is reflected by the detected object 201 to the ranging device 200 in a direction opposite to the projected light 211. Reflected light 212 reflected by the detected object 201 is incident to the collimation element 204 after passing, through the scanner 202.

The detector 205 and the transmitter 203 are arranged on the same side of the collimation element 204, and the detector 205 is configured to convert at least part of the reflected light passing through the collimation element 204 into an electrical signal. In some embodiments, the detector 105 may include an avalanche photodiode, which is a highly sensitive semiconductor device capable of converting an optical signal into an electrical signal using photocurrent effect.

In some embodiments, each optical element is plated with an anti-reflection coating. For example, thickness of the anti-reflection coating is equal to or close to wavelength of the light beam emitted by the transmitter 203, which can increase intensity of the transmitted light beam.

In some embodiments, a filter layer is plated on an element surface located an beam propagation path in the ranging device, or a filter is provided on the beam propagation path, which is configured to at least transmit wavelength band of the beam emitted by the transmitter and reflect other wavelength bands, so as to reduce noise caused by ambient light to receiver.

In some embodiments, the transmitter 203 may include a laser diode, and emit a nanosecond level laser pulse through the laser diode. Further, laser pulse receiving time can be determined, for example, by detecting rising edge time and/or falling edge time of an electrical signal pulse. As such, the ranging device 200 can calculate time of flight (TOF) using pulse receiving time information and pulse sending time information, so as to determine the distance between the detected object 201 and the ranging device 200.

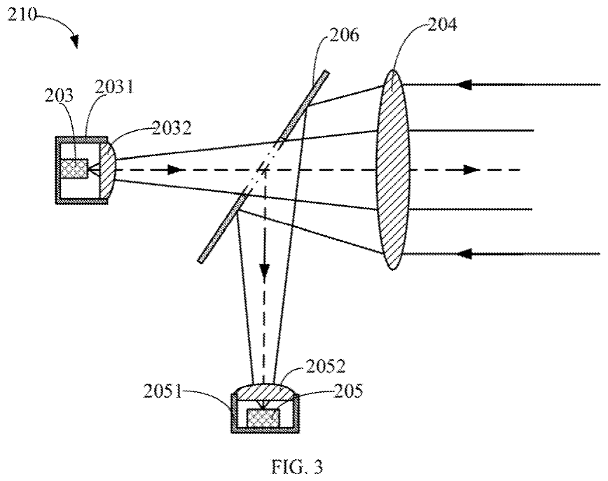

The ranging module described above also includes a first pre-shaping element and/or a second pre-shaping element, such as a pre-collimating lens. The ranging module including the pre-shaping element will be described below with reference to FIGS. 3-7. The technical features in these embodiments are equally applicable to the aforementioned ranging module shown in FIG. 2 under the premise of no conflict.

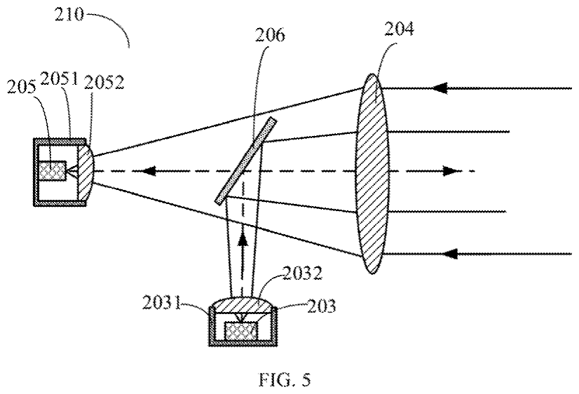

In some embodiments, the light path changing element 206 is located within the back focal length of the collimation element 204, which is configured to change the reception light path of the reflected light passing through the collimation element 204, so that the transmission light path and the reception light path are merged. For example, in the embodiments shown in FIG. 3, the transmission light path of the light pulse sequence emitted by the transmitter 203 is incident to the collimation element 204 through the light path changing element 206, while reception light path of the reflected light converged by the collimation element 204 is changed by the light path changing element and then received by the detector 205. In some other embodiments, the light path changing element 206 is located within the back focal length of the collimation element 204, which is configured to change the transmission light path of the light pulse sequence emitted by the transmitter. For example, as shown in FIG. 5, the light pulse sequence emitted by the transmitter 203 is incident to the collimation element 204 through the light path changing element 206, and at least part of the reflected light converged by the collimation element 204 passes through an outer edge of the light path changing element 206 and is received by the detector 205.

It should be noted that in the present disclosure, a back focal point (also referred to as a backward focal point) refers to a focal point of the optical element or the optical system (such as the collimation element, the converging element, the pre-shaping element) close to the transmitter or close to the detector, while a back focal length (also referred to as a backward focal length) refers to the distance between a back surface apex of the optical element or the optical system and the back focal point; a front focal point (also referred to as a forward focal point) refers to a focal point of the optical element or the optical system (such as the collimation element, the converging element, the pre-shaping element) away from the transmitter or away from the detector, while a front focal length (also referred to as a forward focal length) refers to the distance between a front surface apex of the optical element or the optical system and the front focal point.

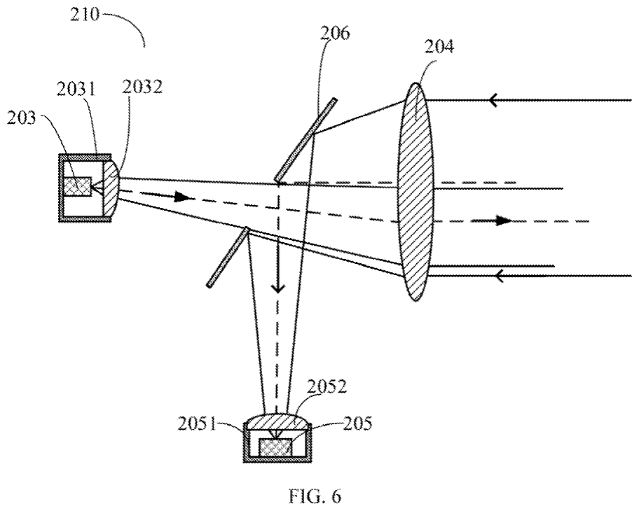

In some embodiments, the light path changing element 206 is arranged on the same side of the collimation element 204 as the transmitter 203 and the detector 205, and the collimation element 204 includes the transceiver lens. In some embodiments, at least one of the light path changing element 206, the detector 205, and the transmitter 203 is arranged at one side of the optical axis of the collimation element 204. For example, in the embodiments shown in FIG. 3, the transmitter 203 is arranged on the optical axis of the collimation element 204, and the detector 205 is arranged at one side of the optical axis of the collimation element 204. In the embodiments shown in FIG. 5, the detector 205 is arranged on the optical axis of the collimation element 204, and the transmitter 203 is arranged at one side of the optical axis of the collimation element 204. Furthermore, center axis of the light pulse sequence emitted by the transmitter 203 and center axis of the reflected light received by the detector can approximately 90°. Reflective surface of the light path changing element 206 is at 45° with the central axis of the light pulse sequence emitted by the transmitter 203, and at 45° with the central axis of the reflected light received by the detector. The above is only an example, and it is not limited to this example. In some other embodiments, the detector 205, the transmitter 203, and the light path changing element 206 can also be arranged at other angles. As another example, in the embodiments shown in FIG. 6, the detector 205 and the transmitter 203 are both arranged at one side of the optical axis of the collimation element 204.

In some embodiments, as shown in FIG. 6, the light path changing element 206 is deviated from the optical axis of the collimation element 204, which is configured to project the light pulse sequence emitted by the transmitter 203 to the edge field of view of the collimation element 204. As such, block of the reflected light by the light path changing element 206 can be reduced as much as possible, and more reflected light can be received by the detector, so as to achieve longer distance or weaker signal detection.

In some embodiments, the light path changing element includes the reflector, and at least part of one of the light pulse sequence emitted by the transmitter and the reflected light reflected by the detected object is transmitted from an outer edge of the reflector, and at least part of the other light is reflected by the reflector. For example, in the embodiments shown in FIG. 5, since the beam aperture of the light beam emitted by the transmitter 203 is small, and the beam aperture of the reflected light received by the ranging device is large, the light path changing element can use a small-area reflector to merge the transmission light path and the reception light path, and at least part of the light pulse sequence emitted by the transmitter 203 is reflected to the collimation clement 204 by the reflector, while at least part of the reflected light reflected by the detected of is projected to the detector 205 from the outer edge of the reflector.

In some other implementations, the light path changing element includes a reflector provided with a light-emission area. At least part of one of the light pulse sequence emitted by the transmitter and the reflected light reflected by the detected object passes through the light-emission area, and at least part of the other light is reflected by an edge of the reflector. The light-emission area includes an opening provided at the reflector. For example, as shown in FIGS. 3 and 6, the light path changing element 206 can also use the reflector with the opening, and the opening is configured to transmit at least part of the light pulse sequence emitted by the transmitter 203, and the reflector is configured to reflect at least part of the reflected light to the detector 205, so that block of the reflected light from a support of a small reflector in case of using the small reflector. For example, the light-emission area includes an anti-reflection coating provided at the reflector, which can increase intensity of the transmitted light beam. For example, a central area of the reflector is the light-emission area made of light-emission material, where the light-emission material is plated with the anti reflection coating, and the edge of the reflector is plated with a high-reflection coating, so as to reflect the light pulse sequence emitted by the transmitter or the reflected light.

In some embodiments, as shown in FIG. 3, at least part of the light pulse sequence emitted by the transmitter 203 passes through the light-emission area, and a light spot area of the light pulse sequence irradiated to the light path changing element 206 is greater than or equal to an area of the light-emission area. When the light spot area is larger than the area of the light-emission area, part of the light pulse sequence is blocked and cannot be used for detection.

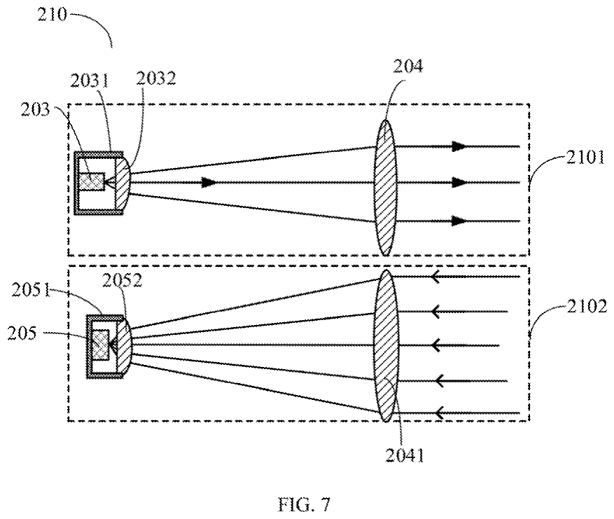

In some other implementations, the transmitter 203 and the detector 205 may respectively use their own collimation elements. For example, as shown in FIG. 7, the transmitter 203 uses the collimation element 204 located on the transmission light path of the transmitter 203, which is configured to collimate the light pulse sequence emitted by the transmitter 203 and then emit it, while the detector 205 uses a converging element 2041 with a converging effect. The converging element 2041 is configured to converge at least part of the reflected light reflected by the detected object to the detector 205, and the light path changing element 206 is arranged on the light path behind the collimation element.

In the embodiments with off-axial transceiver as shown in FIG. 7, the ranging module 210 includes a transmission module 2101 and a reception module 2102. The ranging module 210 also includes a first pre-shaping element 2032 and/or a second pre-shaping element 2052. The first pre-shaping element 2032 is arranged on the transmission light path between the collimation element 204 and the light-emission surface of the transmitter 203, and the second pre-shaping clement 2052 is arranged on the reception light path of the reflected light between the converging element 2041 and the photosensitive surface of the detector 205. Effective aperture of the collimation element 204 is greater than effective aperture of the first pre-shaping element 2032, and effective aperture of the converging element 2041 is greater than effective aperture of the second pre-shaping element 2052. For example, only the first pre-shaping element may be provided on the transmission light path, or only the second pre-shaping element may be provided on the reception light path, or the first pre-shaping element 2032 and the second pre-shaping element 2052 may be respectively provided on the transmission light path and the reception light path.

The light pulse sequence e .witted by the transmitter 203 is first collimated and/or compressed by the first pre-shaping element 2032, thereby increasing energy utilization rate of the transmitter, and then the light pulse sequence is collimated and/or compressed again by a collimation element with a large aperture, so that collimation characteristic of the light pulse sequence emitted by the transmitter is significantly improved. On the reception light path of the reflected light, the reflected light is converged by the converging element (or the collimation element on coaxial transceiver light path), and then the reflected light is converged again by the second pre-shaping element, thereby improving reception rate of the reflected light, which is conducive to improve a signal-to-noise ratio of the ranging device. In addition, due to the large effective aperture of the converging element, more reflected light reflected by the detected objects can be received, which is conducive to achieve longer distance or weaker signal detection of the ranging device.

An effective focal length of the collimation element 204 is greater than an effective focal length of the first pre-shaping element 2032, for example, the of focal length of the collimation element 204 is greater than or equal to 10 times the effective focal length of the first pre-shaping element 2032. Further, a backward focal length of the collimation element 204 is greater than or equal to 10 times a forward focal length of the first pre-shaping element 2032. In some embodiments, an effective focal length of the converging element 2041 is greater than an effective focal length of the second pre-shaping element 2052, for example, the effective focal length of the converging element 2041 is greater than or equal to 10 times the effective focal length of the second pre-shaping element 2052. Further, as shown in FIG. 7, a backward focal length of the converging element 2041 is greater than or equal to 10 times a forward focal length of the second pre shaping element 2052, or, as shown in FIG. 3, the transmission light path and the reception light path can share the same collimation element 204, and the backward focal length of the collimation element 204 is greater than or equal to 10 times the forward focal length of the second pre-shaping element 2052. The above numerical ranges are examples only, and other suitable numerical ranges can also be applied to the embodiments of the present disclosure.

The first pre-shaping element and the second pre-Shaping element may include a short focal length lens. For example, a focal length range of the first pre-shaping element is between 10 μm and 10 mm, and/or a focal length range of the second pre-shaping element is between 10 μm and 10 mm, or another suitable focal length range, which can also be applied to the structures shown in FIGS. 3-6. For example, as shown in FIG. 7, an effective focal length range of a first optical system is between 20 mm and 200 mm, and/or an effective focal length range of a second optical system is between 20 mm and 200 mm. The above numerical ranges are examples only, and other suitable numerical ranges can also be applied to the embodiments of the present disclosure.

Generally, in an optical system that includes multiple lenses, an effective focal length is a distance from a principal plane of the system to corresponding front and back focal points. In the optical system, a system focal length is usually expressed as the effective focal length. A front focal length of the optical system is a distance from the front focal point of the system to an apex of a first optical surface, and a back focal length is a distance from an apex of a last optical surface of the system to the back focal point.

For example, the first pre-shaping element 2032 includes an aspheric lens, and the second pre-shaping element 2052 includes an aspheric lens. The first pre-shaping element 2032 and the second pre-shaping element 2052 can be the same lens or different lenses, and the first pre-shaping element 2032 and the second pre-shaping element 2052 can also be another type of lens, such as a cylindrical lens, a spherical lens, a spherical lens group, or a combination of the lenses described above.

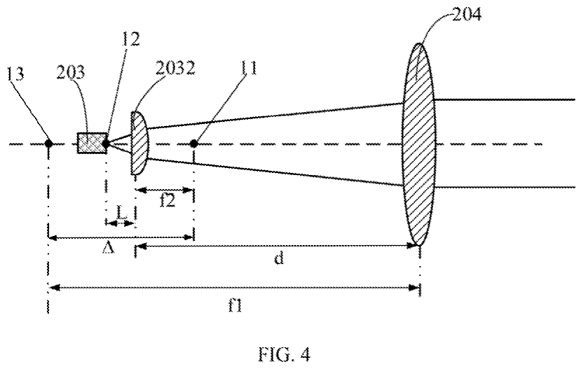

The ranging module 210 described above includes the first pre-shaping element 2032 and/or the second pre-shaping element 2052. Positional relationships among various elements are specifically described with reference to FIGS. 3 and 4, but it is understandable that the positional relationships are also applicable to other structural types of the ranging module in the embodiments of the present disclosure.

In the embodiments with coaxial transceiver as shown in FIG. 3, the ranging module 210 shares the same collimation element through the light path changing element 206 to merge the transmission light path and the reception light path within the ranging device before the collimation element 204, so that the transmission light path and the reception light path can share the same collimation element 204, for example, share the same transceiver lens, which makes the light path more compact.

For example, as shown in FIG. 3, the first optical system includes the collimation element 204 and the first pre-shaping element 2032, and the light-emission surface of the transmitter 203 is located between a backward focal. point of the collimation element 204 and the first pre-shaping element 2032. For example, the light-emission surface of the transmitter 203 is located on a focal plane of the first optical system, such as, the light-emission surface of the transmitter 203 is located on a back focal plane of the first optical system, especially the light-emission surface of the transmitter is arranged on the back focal plane of the first optical system. The “focal plane” herein refers to a plane that passes the focal point of the corresponding optical system and is perpendicular to the optical axis of the optical system. The light-emission surface of the transmitter is arranged on the focal plane of the first optical system, which has a better collimation effect on the light pulse sequence emitted by the transmitter.

In the embodiments shown in FIG. 7, the second optical system includes the converging element 2041 and the second pre-shaping element 2052, or, in the embodiments shown in FIG. 3, the second optical system includes the collimation element 204 and the second pre-shaping element 2052. The detector includes the photosensitive surface located on a focal plane of the second optical system. For example, the photosensitive surface of the detector 205 is arranged on a back focal point of the second optical system, especially the photosensitive surface of the detector 205 is arranged on a back focal plane of the second optical system, so as to achieve a relatively better convergence effect and improve detection accuracy of the detector.

Distance from the transmitter 203 to the light path changing element 206 is not necessarily equal to distance from the detector 205 to the light path changing element 206. As shown in FIG. 3, when a focal length of the first optical system is equal to a focal length of the second optical system, the transmitter 203 is arranged on the back focal plane of the first optical system. When the first pre-shaping element 2032 and the second pre shaping element 2052 are substantially the same element, since the distance from the transmitter 203 to the light path changing element 206 is equal to the distance from the detector 205 to the light path changing element 206, then the detector is equivalent to being arranged on the hack focal plane of the second optical system, in which case the convergence effect of the reflected light is better.

Specifically, referring to FIG. 4, positional relationships among the transmitter, the first pre-shaping element, and the collimation element and positional relationships among the detector, the second pre-shaping element, and the collimation element (or the converging element) in the optical system are explained and described. Although FIG. 4 only shows part of the elements on the transmission light path in FIG. 3, it can be understood that the following positional relationships are also applicable to the corresponding elements on the reception light path, and is also applicable to other embodiments. FIG. 4 shows a forward focal point 11 of the first pre-shaping element 2032, a backward focal point 12 of the first optical system including the collimation element 204 and the first pre-shaping element 2032, and a backward focal point 13 of the collimation element 204. Correspondingly, the backward focal length of the collimation element 204 is f1, and the forward focal length of the first pre-shaping element 2032 is f2. Distance between the forward focal point 11 of the first pre-shaping element 2032 and the backward focal point 13 of the collimation element 204 is Δ, where Δ is greater than f2, and f1 is greater than f2. Distance between the light-emission surface of the transmitter 203 and the first pre-shaping element 2032 is L, and center distance between the collimation element 204 and the first pre-shaping element 2032 is d.

For example, at least two of emission optical axis of the transmitter 203 (that is, the central axis of the light pulse sequence emitted by the transmitter), optical axis of the first pre-shaping element 2032, and the optical axis of the collimation element 204 are coaxial. The distance between the light-emission surface of the transmitter 203 and the first pre-shaping element 2032 is smaller than the focal length of the first pre-shaping element 2032, and in particular, is smaller than the forward focal length of the first pre-shaping element 2032. For example, the distance L between the light-emission surface of the transmitter 203 and the first pre-shaping element 2032 satisfies the following formula:

$$L = f 2 \times ( 1 - \frac{f 2}{Δ} )$$

Similarly, distance between the photosensitive surface of the detector 205 and the second pre-shaping element 2052 in FIG. 3 can be calculated by the above formula. Since the detector 205 is located at one side of the optical axis of the collimation element 204 in FIG. 3, it can be rotated around an intersection of a central axis of the reception light path and a central axis of the transmission light path in direction of the transmitter, so that the central axis of the reception light path coincides with the central axis of the transmission light path, and equivalent calculation can be performed. It is only needed to replace Δ with an equivalent distance between a forward focal point of the second pre-shaping element and the backward focal point of the collimation element 204 on the optical axis of the collimation element, and replace f2 with the forward focal length of the second pre-shaping element, where the equivalent distance is greater than the forward focal length of the second pre-shaping element. At least two of a receiving optical axis of the detector 205 (that is, the central axis of the reflected light reflected by the detected object received by the detector), an optical axis of the second pre-shaping elements 2052, and the optical axis of the collimation element 204 are coaxial. The distance between the photosensitive surface of the detector 205 and the second pre-shaping element 2052 is smaller than the local length of the second pre-shaping element 2052, in particular, is smaller than the forward focal length of the second pre-shaping element 2052.

A focal length f (or an effective focal length) of the first optical system satisfies the following formula:

$$f = \frac{f 1 \times f 2}{f 1 + f 2 - d}$$

The distances in the formula are all positive, and the focal length f of the entire first optical system, under the premise that f1 and f2 are known, changes accordingly when the distance d between the first pre-shaping element 2032 and the collimation element 204 is adjusted, where f increases if d decreases, and f decreases if d increases. Therefore, value of the focal length f of the optical system depends on value of the distance d between the pre-shaping element and the collimation element, and similarly, the value of the distance d depends on the focal length f of the optical system, so that the center distance d between the first pre-shaping clement 2032 and the collimation element 204 is limited.

Similarly, the focal length f of the second optical system can be calculated by the above formula. The center distance d between the second pre-shaping element and the collimation element is also equivalent to the distance on the optical axis of the collimation element, and then the for local length f2 of the pre-shaping element 2052 and the backward focal length f1 of the collimation element 204 are substituted into the above formula to calculate the focal length f of the second optical system.

As shown in FIG. 4 again, an effective divergence angle β of the light pulse sequence emitted by the transmitter 203 satisfies the following formula:

β≤180×D/(π×f)

D is the effective aperture of the collimation element, f is the focal length of the first optical system, and the effective divergence angle refers to a divergence angle of the light pulse sequence actually incident to the collimation element. For example, since the collimation element is provided with the optical element such as the light path changing element 206, the light path changing element 206 can only cause part of the light pulse sequence to be incident to the collimation element 204.

It should be noted that the effective aperture herein refers to the maximum aperture of the corresponding optical element (such as the collimation element, the converging element, the pre-shaping element) that is actually used to collimate the light pulse sequence emitted by the transmitter and the reflected light received by the detector.

In some embodiments, as shown in FIGS. 3 and 5-7, the effective divergence angle of the light pulse sequence emitted b the transmitter 203 is smaller than an effective reception angle of the detector 205, so that the detector 205 can receive more reflected light.

An effective photosensitive size of the detector 205 is greater than or equal to twice the size of an Airy disk of the second optical system. For example, the effective photosensitive size of the detector is greater than or equal to twice the diameter of the Airy disk D1 of the second optical system, and the diameter of the Airy disk D1 can be obtained by the following formula:

$$D 1 = \frac{2.44 \times λ f}{D}$$

D is the effective aperture of the second optical system, f is the effective focal length of the second optical system, and λ is the wavelength of the light pulse sequence emitted by the transmitter.

Airy disk is a light spot formed at the focal point due to diffraction when a point light source is imaged through an ideal lens. The center is a bright round spot, surrounded by a set of weaker light and dark concentric ring stripes. A central bright spot bounded by the first dark ring is called Airy disk. The effective photosensitive size of the detector 205 is greater than or equal to twice the size of the Airy disk of the second optical system, so that the detector 205 can receive more light in addition to the Airy disk formed by the reflected light on the photosensitive surface, which can improve photosensitive performance of the detector.

For example, the effective photosensitive size of the detector 205 is greater than an effective light-emission size of the transmitter 203, where the effective photosensitive size refers to the size of the photosensitive surface of the detector 205 actually used for light-sensing, such as area, etc., while the effective light-emission size refers to the size of the light-emission surface of the transmitter actually used to emit the laser pulse sequence, such as area, etc.

Shape of the photosensitive surface of the detector 205 includes a circle, an ellipse, a rectangle, or another suitable shape, which is not specifically limited herein.

In the embodiments shown in FIGS. 3 and 5-7, the transmitter 203 and the first pre shaping element 2032 are integrally packaged; and/or, the detector 205 and the second pre-shaping element 2052 are integrally packaged. The transmitter and the detector are each packaged together with the corresponding pre-shaping element thereto by a mature packaging process, so that integration is higher, production difficulty is reduced, and mass production is facilitated.

In some embodiments, as shown in FIGS. 3 and 5-7, the ranging device also includes a substrate (not shown) and a housing 2031. The substrate is configured to carry the transmitter 203, and the substrate (not shown) is configured to be mounted on a circuit board. The housing 2031 is provided on the surface of the substrate or the circuit hoard, so as to form an accommodation space between the substrate and the housing. The housing is at least partially provided with the light-emission area, and the transmitter 203 is provided in the accommodation space. The first pre-shaping element 2032 is provided at the light-emission area, and the light emitted from the transmitter 203 is emitted through the first pre-shaping element 2032. For example, the first pre-shaping element 2032 is fixed at the light-emission area by form-sealed bonding or welding, or another suitable manner.

Similarly, the detector and the second pre-shaping element can also be packaged in the manner described above. The ranging device also includes a substrate (not shown) and a housing 2051. The substrate is configured to carry the detector 205, and the substrate (not shown) is configured to be mounted on a circuit board. The housing 2051 is provided on the surface of the substrate or the circuit board, so as to form an accommodation space between the substrate and the housing. The housing is at least partially provided with the light-emission area, and the detector 205 is provided in the accommodation space. The second pre-shaping element 2052 is provided at the light-emission area, and the light emitted from the detector 205 is emitted through the second pre-shaping element 2052. For example, the second pre-shaping element 2052 is fixed at the light-emission area by form-sealed bonding or welding, or another suitable manner.

In some other embodiments, the ranging device also includes a bracket (not shown), and the first pre-shaping element 2032 is arranged at the bracket, so that the first pre-shaping element is fixed by the bracket. Similarly, the ranging device also includes a bracket (not shown), and the second pre-shaping element is arranged at the bracket, so that the second pre-shaping element, is fixed by the bracket.

In some other embodiments, the ranging device also includes a first seal body (not shown). The transmitter 203 is embedded in the first seal body, and the first pre-shaping element is arranged on an outer surface of the first seal body, which is configured to preliminarily compress the light pulse sequence emitted by the transmitter. The first pre-shaping element may be arranged on the outer surface of the first seal body by bonding or welding, or the first seal body and the first pre-shaping element can be integrally formed. Similarly, the detector and the second pre-shaping element can also be integrally packaged in the manner described above. The ranging device also includes a second seal body (not shown). The detector 205 is embedded in the second seal body, and the second pre-shaping element is arranged on an outer surface of the second seal body, which is configured to preliminarily compress the light pulse sequence omitted by the transmitter. The second pre-shaping element may be arranged on the outer surface of the second seal body by bonding or welding, or the second seal body and the second pre-shaping element can be integrally formed.

Thus, the description of the ranging device according to the embodiments of the present disclosure has been done. Other components and structures may also be included for a complete ranging device, which will not be repeated herein.

In summary, the ranging device according to the embodiments of the present disclosure combines the large-aperture collimation element (or the converging element) with the small-aperture pre-shaping element to form the optical system, which can be equivalent to a large aspheric lens capable of achieving excellent optical performance under a large-aperture lens at a lower cost, reducing aberration of the optical system, etc., which is beneficial to improve the performance of the ranging device such as a laser radar. Through preliminary collimation of the emitted light pulse sequence by the pre-shaping element (such as a pre-collimating lens) and re-convergence and compression of the reflected light reflected by the detected object, energy utilization rate of the transmitter (such as a laser) can be increased, and the collimation characteristic of the light pulse sequence emitted by the transmitter can be improved, and meanwhile, reception of the reflected light is more efficient, which is conducive to improve the signal-to-noise ratio of the system. In addition, since the laser/detector can be packaged together by a mature packaging process, the integration is higher, the production difficulty is reduced, and the mass production is facilitated. Therefore, compared with other conventional systems of small-aperture lenses and large-aperture lenses, the solution of the embodiments of the present disclosure overcomes the problems of complex structure and high production difficulty in the conventional systems.

The distance and orientation detected by the ranging device 200 can be used for remote sensing, obstacle avoidance, surveying and mapping, modeling, navigation, etc. In some embodiments, the ranging device according to the embodiments of the present disclosure can be applied to a mobile platform, and the ranging device can be mounted at a platform body of the mobile platform. The mobile platform with the ranging device can measure external environment, for example, to measure distance between the mobile platform and an obstacle for obstacle avoidance and other purposes, and to perform two-dimensional or three-dimensional surveying and mapping of the external environment. In some embodiments, the mobile platform includes at least one of an unmanned aerial vehicle, a car, a remote control vehicle, a robot, a camera, or a boat. When the ranging device is applied to an unmanned aerial vehicle, the platform body is a vehicle body of the unmanned aerial vehicle. When the ranging device is applied to a car, the platform body is a vehicle body of the car. The car can be a self-driving car or a semi-self-driving car, which is not limited here. When the ranging device is applied to a remote control vehicle, the platform body is a vehicle body of the remote control vehicle. When the ranging device is applied to a robot, the platform body is the robot. When the ranging device is applied to a camera, the platform body is the camera itself.

Although the exemplary embodiments have been described herein with reference to the accompanying drawings, it should be understood that the exemplary embodiments described above are merely exemplary, and are not intended to limit the scope of the present disclosure thereto. Those of ordinary skill in the art can make various changes and modifications therein without departing from the scope and spirit of the present disclosure. All these changes and modifications are intended to be included within the scope of the present disclosure as claimed in the appended claims.

Those of ordinary skill in the art may realize that the units and algorithm steps of the examples described in the embodiments disclosed herein can be implemented by electronic hardware or a combination of computer software and electronic hardware. Whether these functions are executed by hardware or software depends on the specific application and design constraints of the technical solutions. Professionals and technicians can use different methods for each specific application to implement the described functions, but such implementation should not be considered beyond the scope of the present disclosure.

It should be understood that, in some embodiments provided by the present disclosure, the disclosed device and method can be implemented in other manners. For example, the example device described above is only illustrative. For example, the division of the modules or units is only a logical function division, and there may be other divisions in actual implementation, e.g., multiple units or components may be combined or integrated into another device, or some features may be omitted or not performed.

In the specification provided here, a lot of specific details are described. However, it can be understood that the embodiments of the present disclosure can be implemented without these specific details. In some embodiments, well-known methods, structures, and technologies are not shown in detail, so as not to obscure the understanding of this specification.

Similarly, it should be understood that in order to simplify the present disclosure and help the understanding of one or more of the various aspects of the disclosure, the various features of the present disclosure are sometimes grouped together into a single embodiment, figure, or description thereof in the description of the exemplary embodiments of the present disclosure. However, the method of the present disclosure should not be construed as reflecting the intention that the claimed disclosure requires more features than those explicitly stated in each claim. More precisely, as reflected in the corresponding claims, the point of the disclosure is that the corresponding technical problems can be solved with features that are less than all the features of a single disclosed embodiment. Therefore, the claims following the specific embodiments are thus explicitly incorporated into the specific embodiments, where each claim itself serves as a separate embodiment of the present disclosure.

Those skilled in the art can understand all features, other than those mutually exclusive, disclosed in this specification (including the accompanying claims, abstract, and drawings) and all processes or units of any method or device disclosed can be employed in any combination. Unless expressly stated otherwise, each feature disclosed in this specification (including the accompanying claims, abstract, and drawings) may be replaced by an alternative feature providing the same, equivalent, or similar purpose.

In addition, those skilled in the art can understand that although some embodiments described herein include certain features included in other embodiments rather than other features, the combination of features of different embodiments means that they are within the scope of the present disclosure and form different embodiments. For example, in the claims, any one of the claimed embodiments can be used in any combination.

The various component embodiments of the present disclosure may be implemented by hardware, or by software module running on one or more processors, or by a combination thereof. Those skilled in the art should understand that a microprocessor or a digital signal processor (DSP) may be used in practice to implement some or all of the functions of some modules according to the embodiments of the present disclosure. The present disclosure can also be implemented as a device program (for example, a computer program and a computer program product) for executing part or all of the methods described herein. Such a program implementing the present disclosure may be stored on a computer-readable medium, or may have the form of one or more signals. Such signals can be downloaded from an Internet website, or provided in carrier signals, or provided in any other form.

It should be noted that the embodiments described above illustrate rather than limit the present disclosure, and those skilled in the art can design alternative embodiments without departing from the scope of the appended claims. In the claims, any reference symbols placed between parentheses shall not be constructed as a limitation to the claims. The present disclosure can be implemented by means of hardware including several different elements and by means of a suitably programmed computer. In the unit claims listing several devices, several of these devices may be embodied in the same hardware item. The use of the words first, second, and third, etc. do not indicate any order. These words can be interpreted as names.

What is claimed is:

1. A ranging device comprising:
a transmitter configured to emit a light pulse sequence;
a collimation element located on a transmission light path of the transmitter and configured to collimate the light pulse sequence for emitting from the ranging device;
a converging element configured to converge at least part of reflected light reflected by an object;
a detector configured to receive and convert the at least part of the reflected light to an electrical signal, and determine at least one of a distance or an orientation of the object with respect to the ranging device according to the electrical signal; and
at least one of a first pre-shaping element or a second pre-shaping element, the first pre-shaping element being in on the transmission light path and between the collimation element and a light-emission surface of the transmitter, and the second pre-shaping element being arranged on a reception light path of the reflected light and between the converging element and a photosensitive surface of the detector;
wherein an effective aperture of the collimation element is greater than an effective aperture of the first pre-shaping element, and an effective aperture of the converging element is greater than an effective aperture of the second pre-shaping element.

2. The ranging device of claim 1, wherein:
an effective focal length of the collimation element is greater than or equal to 10 times an effective focal length of the first pre-shaping element; and/or
an effective focal length of the converging element is greater than or equal to 10 times an effective focal length of the second pre-shaping element.

3. The ranging device of claim 1, wherein:
at least two of an emission optical axis of the transmitter, a optical axis of the first pre-shaping element, and an optical axis of the collimation element are coaxial; and
a distance between the light-emission surface of the transmitter and the first pre-shaping element is smaller than a focal length of the first pre-shaping element.

4. The ranging device of claim 3, wherein the light-emission surface of the transmitter is located between a backward focal point of the collimation element and the first pre-shaping element.

5. The ranging device of claim 1, wherein:
the light-emission surface of the transmitter is located on a focal plane of a first optical system that includes the collimation element and the first pre-shaping element; and/or
the photosensitive surface of the detector is located on a focal plane of a second optical system that includes the converging element and the second pre-shaping element.

6. The ranging device of claim 5, wherein an effective photosensitive size of the detector is greater than or equal to twice a size of an Airy disk of the second optical system.

7. The ranging device of claim 6, wherein the effective photosensitive size of the detector is greater than or equal to twice a diameter of the Airy disk of the second optical system.

8. The ranging device of claim 5, wherein:
an effective focal length range of the first optical system is between 20 mm and 200 mm; and/or
an effective focal length range of the second optical system is between 20 mm and 200 mm.

9. The ranging device of claim 1, wherein an effective divergence angle of the light pulse sequence emitted by the transmitter is smaller than an effective reception angle of the detector.

10. The ranging device of claim 1, wherein the effective photosensitive size of the detector is greater than an effective light-emission size of the transmitter.

11. The ranging device of claim 1, wherein a shape of the photosensitive surface of the detector includes a circle, an ellipse, or a rectangle.

12. The ranging device of claim 1, wherein:
the transmitter and the first pre-shaping element are integrally packaged; and/or
the detector and the second pre-shaping element are integrally packaged.

13. The ranging device of claim 12, further comprising:
a first seal body, the transmitter being embedded in the first seal body, and the first pre-shaping element being arranged on an outer surface of the first seal body to compress the light pulse sequence emitted by the transmitter; and/or
a second seal body, the detector being embedded in the second seal body, and the second pre-shaping element being arranged on an outer surface of the second seal body to converge the reflected light.

14. The ranging device of claim 13, wherein:
the first seal body and the first pre-shaping element are integrally formed; and/or
the second seal body and second first pre-shaping element are integrally formed.

15. The ranging device of claim 12, further comprising:
a substrate configured to carry the transmitter and to be mounted on a circuit board; and
a housing provided on a surface of the substrate;
wherein:
an accommodation space is formed between the substrate and the housing, the transmitter being provided in the accommodation space; and
the housing is at least partially provided with a light-emission area, the first pre-shaping element being provided at the light-emission area, and light emitted from the transmitter being emitted through the first pre-shaping element.

16. The ranging device of claim 15, further comprising:
a bracket;
wherein the first pre-shaping element is arranged at the bracket to be fixed by the bracket.

17. The ranging device of claim 16, further comprising;
a substrate configured to carry the detector and to be mounted on a circuit board; and
a housing provided on a surface of the substrate;
wherein:
an accommodation space is formed between the substrate and the housing, the transmitter being provided in the accommodation space; and
the housing is at least partially provided with a light-emission area, the first pre-shaping element being provided at the light-emission area, and the reflected light converged through the second pre-shaping element being emitted to the detector.

18. The ranging device of claim 17, wherein the second pre-shaping element is fixed at the light-emission area by bonding or welding.

19. The ranging device of claim 17, further comprising;
a bracket;
wherein the second pre-shaping element is arranged at the bracket to be fixed by the bracket.

20. The ranging device of claim 1, wherein:
the first pre-shaping element includes an aspheric lens; and/or the second pre-shaping element includes an aspheric lens.

21. The ranging device of claim 1, further comprising:
a scanner configured to sequentially change a propagation path of the light pulse sequence collimated by the collimation element to different directions to emit, to form a scanning field of view.

22. A mobile platform comprising:
a platform body; and
a ranging device mounted at the platform body and including:
a transmitter configured to emit a light pulse sequence;
a collimation element located a transmission light path of the transmitter and configured to collimate the light pulse sequence for emitting from the ranging device;
a converging element configured to converge at least part of reflected light reflected by an object;
a detector configured to receive and convert the at least part of the reflected light to an electrical signal, and determine at least one of a distance or an orientation of the object with respect to the ranging device according to the electrical signal; and
at least one of a first pre-shaping element or a second pre-shaping element, the first pre-shaping element being arranged on the transmission light path and between the collimation element and a light-emission surface of the transmitter, and the second pre-shaping element being arranged on a reception light path of the reflected light and between the converging element and a photosensitive surface of the detector;
wherein an effective aperture of the collimation element is greater than an effective aperture of the first pre-shaping element, and an effective aperture of the converging element is greater than an effective aperture of the second pre-shaping element.
